(19) United States
(12) Patent Application Publication
(10) Pub. No.: US 2007/0098310 A1
(43) Pub. Date: May 3, 2007

(54) Oil-suspending and oil-retaining bearing

(75) Inventors: Alex Hong, Kaohsiung City (TW); Yin Rong Hong, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/272,677

(22) Filed: Nov. 15, 2005

(30) Foreign Application Priority Data
Oct. 28, 2005 (TW) 94137784

(51) Int. Cl. F16C 32/06

(52) U.S. Cl. 384/100

(57) ABSTRACT

The invention relates to an oil-suspending and oil-retaining bearing. The bearing has a bore for the spindle of the rotor to penetrate therein. The periphery of at least one end penetrated by the bore is disposed a slotted ring inserted with the absorbent material beforehand. The end of the bearing has a plurality of guiding slots and the periphery of the bearing also has a plurality of guiding slots. Therefore, when lubricating oil seeps and diffuses due to the agitation of the spindle, the rising lubricating oil is collected by the guiding slots and guided into the slotted ring. In addition to blocking and suspending lubricating oil, the absorbent material in the slotted ring not only absorbs and store lubricating oil, but also provides the bearing the timely reuse and circulation of lubricating oil, effectively avoiding the drainage of lubricating oil and prolonging the life cycle of motor.

### FIELD OF THE INVENTION

The invention relates to an oil-suspending and oil-retaining bearing, which also is featured by suspending, storing and circulating lubricating oil so as to enhance the motor rotation efficiency and prolong the life cycle of motor.

### BACKGROUND OF THE INVENTION

Motor can be also named as the core of electronic products. The hunger for motor speed in modern technology seems to be endless. However, the increase of motor speed is often restrained by the lubrication of bearing. As a result, the search for better lubrication technique and the effective protection regarding the drainage of lubricating oil are the key while increasing the motor speed.

As shown in FIG. 1, the motor fan has a rotor 10 and a stator 20. A spindle 11 is disposed on top of the rotor 10. The bearing 30 is held and positioned by a position ring 22 and a cap 23. The spindle 11 of the rotor 10 centrally penetrating through the bore 31 and rotating therein is fastened by a snap ring 24 underneath the bearing 30 so as to prevent the rotor 10 from stripping.

Please also refer to FIG. 2. When the spindle 11 of the rotor 10 in the conventional motor structure is rotating, the lubricating oil contained inside the cap 23 seeps and diffuses to the wall of the shaft tube 21 and flows upwardly along the gap between the bearing 30 and the shaft tube 21 due to the agitation out of the centrifugal force caused by the rotation of the spindle 11 and lastly drains from the gap between the positioning ring 22 and the shaft tube 21. As the lubricating oil is the lubrication medium served for the rotation of the spindle 11 with respect to the bearing 30, what the drainage of the lubricating oil affects most directly is the lower rotation efficiency of the spindle 11 and the attrition.

As a consequence, for sake of avoiding the attrition of the spindle, enhancing the rotation efficiency of the spindle and prolonging the operational duration of motor, a better lubrication technique particularly featured by suspending, storing and circulating the lubricating oil so as to completely resolve the aforementioned issues.

### SUMMARY OF THE INVENTION

Accordingly, the present invention provides an oil-suspending and oil-retaining bearing being multi-functional in suspending, storing and circulating oil so as to avoid the attrition of the spindle, enhance the rotation efficiency of the spindle and prolong the life cycle of the motor, wherein the motor structure includes a rotor disposed a spindle therein, and a stator centrally disposed a shaft tube accommodating a bearing therein, a bore is provided for the spindle of the rotor to centrally penetrate through the bearing and rotate therein, at least one end face of the bearing penetrated by the bore has an slotted ring disposed with absorbent material in advance, the end face of the bearing having the slotted ring contains a plurality of guiding slots, and the periphery of the bearing is also disposed a plurality of guiding slots.

As such, when lubricating oil seeps and diffuses to the wall of the shaft tube due to the agitation of the spindle, the rising lubricating oil is collected by the guiding slot and guided into the slotted ring. In addition to blocking and suspending the lubricating oil, the absorbent material in the slotted ring also absorbs and stores lubricating oil providing the timely absorption and circulation for the bearing so as to effectively prevent lubricating oil from draining and the spindle from being worn down. Hence, the rotation efficiency of the spindle is enhanced and the life cycle of the motor is prolonged.

### BRIEF DESCRIPTION OF THE DRAWINGS

FIG. 1 is a schematic view fully showing the cross section of the conventional structure;

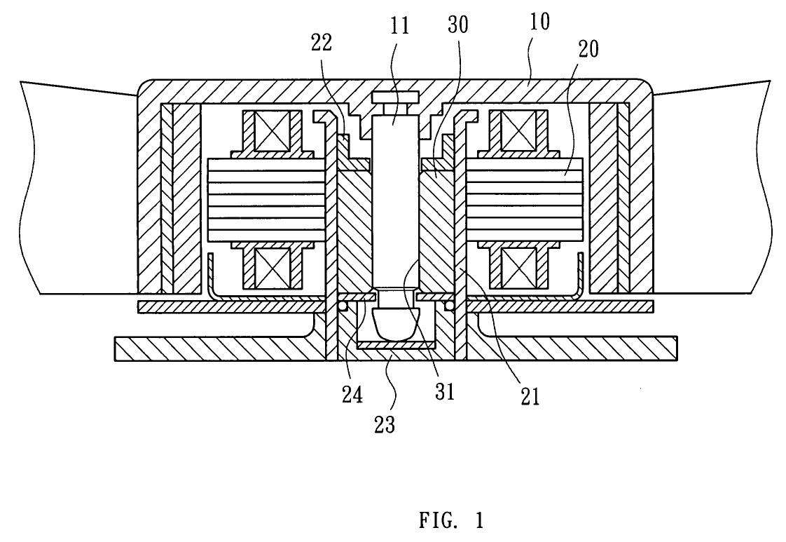

FIG. 2 is an enlarged schematic view partially showing the conventional structure;

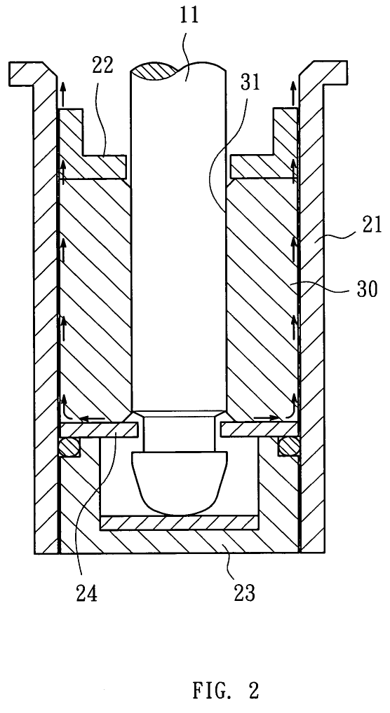

FIG. 3 is a schematic view showing the appearance of the first preferred embodiment of the present invention;

FIG. 4 is a cross-sectional schematic view fully showing the first preferred embodiment of the present invention;

FIG. 5 is an enlarged schematic view partially showing the first preferred embodiment;

FIG. 6 is a cross-sectional schematic view fully showing the second preferred embodiment; and

FIG. 7 is an enlarged schematic view partially showing the second preferred embodiment.

### DETAILED DESCRIPTION OF THE PREFERRED EMBODIMENT

The invention relates to an oil-suspending and oil-retaining bearing disposed an absorbent material and plural guiding slots thereon, wherein the guiding slots are featured by collecting the rising lubricating oil to attain the circulation effect, and the absorbent material suffices to suspend and storing lubricating oil.

Two preferred embodiments listed below are applied to depict the respective position of each part in the present invention;

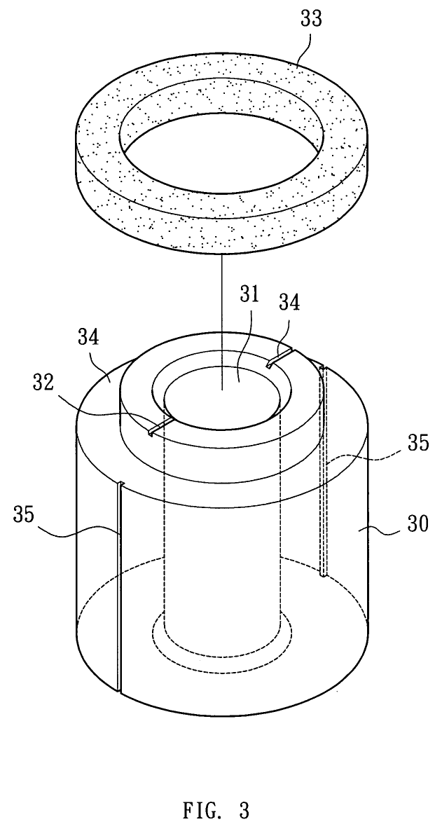

Please refer to FIG. 3 showing the first preferred embodiment of the present invention, wherein a bearing 30 has a bore 31 axially penetrating the bearing 30, an slotted ring is disposed on at least one end face of the bearing 30 penetrated by the bore 31, and the slotted ring 32 in annular form is inserted with an absorbent material 33 intended to be the material absorbing and storing lubricating oil, e.g. oil absorbent or woolen felt. Besides, the end face of the slotted ring 32 has a plurality of radial guiding slots 34, and the periphery of the bearing 30 has also a plurality of vertical guiding slots 35.

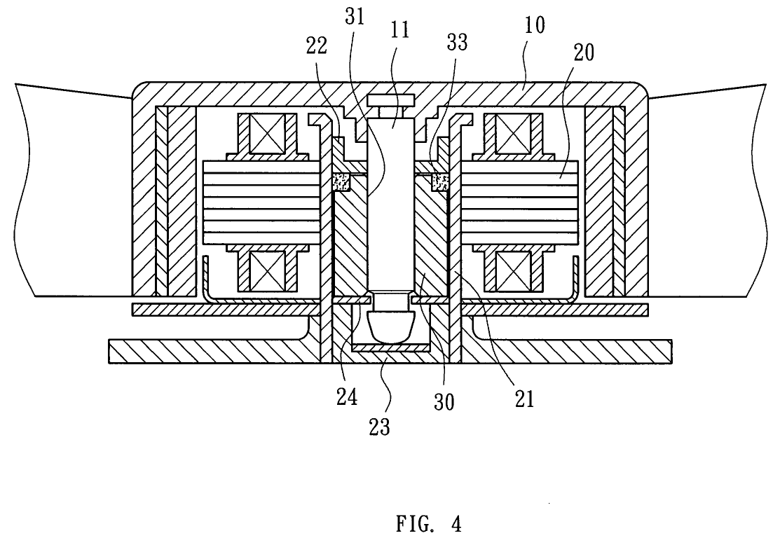

Please also refer to FIG. 4. A fan motor comprises a rotor 10 disposed a spindle 11, a stator 20 centrally disposed a shaft tube 21, wherein the bearing 30 is inserted in the shaft tube 21, one side of the bearing 30 disposed a slotted ring 32 faces upwardly, the bearing 30 is fastened and positioned by a positioning ring 22 and a cap 23 so that the spindle 11 of the rotor 10 penetrates the bore 31 of the bearing, rotates therein and is fastened by a snap ring 24 disposed underneath the bearing 30 beforehand to prevent the rotor 10 from stripping.

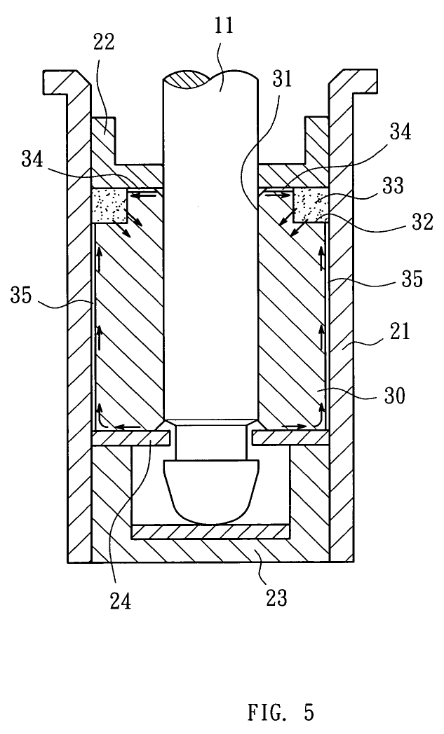

As also shown in FIG. 5, when the lubricating oil stored in the cap 23 seeps and diffuses to the wall of the shaft tube 21 due to the agitation out of the centrifugal force caused by the rotation of the spindle 11 and rises up along the gap between the bearing 30 and the shaft tube 21, the guiding slots 34, 35 are used to guide the lubricating oil into the space of the slotted ring 32 before the collected rising lubricating oil reaches the positioning ring 22. In addition to blocking and suspending lubricating oil to drain from the gap of the positioning ring, the space of the slotted ring 32 is filled with the absorbent material 33 for absorbing and storing lubricating oil to provide the bearing the timely absorption and utilization repeatedly at the right moment, effectively preventing lubricating oil from draining.

Moreover, the present invention may take the forms of the following patterns.

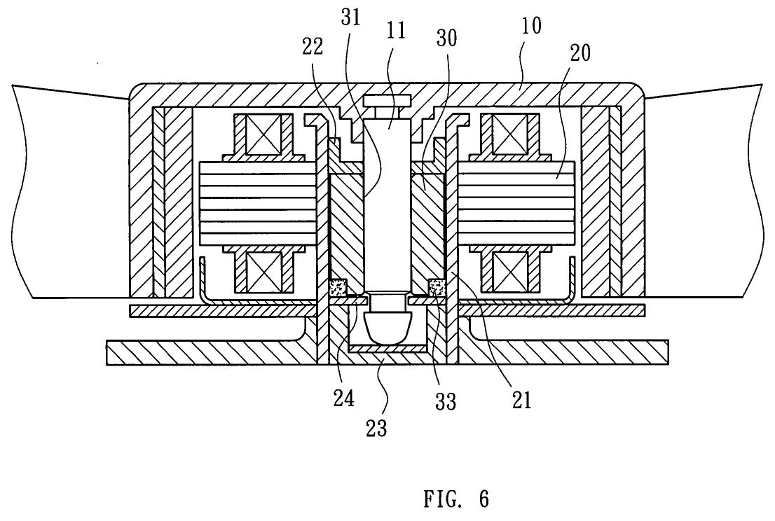

As shown in FIG. 6 showing the second preferred embodiment of the present invention, when the bearing 30 is disposed inside the shaft tube 21, the end face having the slotted ring 32 faces downwardly.

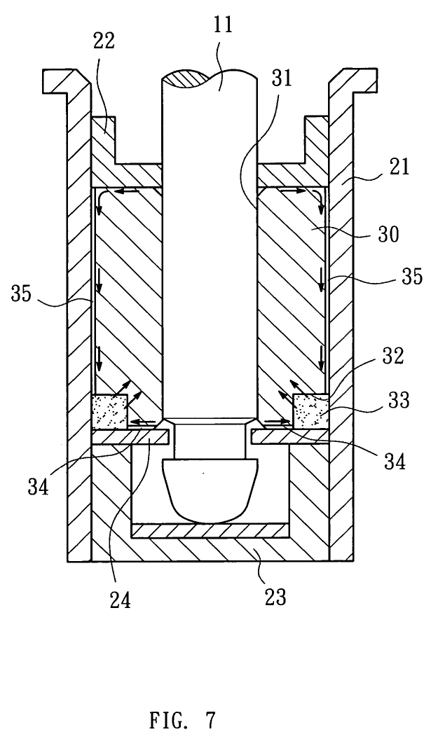

Together with the illustration of FIG. 7, the guiding slots 34, 35 on the bearing 30 are equally featured by collecting the rising lubricating oil. Meanwhile, the absorbent material 33 located at the bottom side of the bearing 30 directly blocks the lubricating oil diffused from side the cap 23 so as to provide the bearing 30 the absorption and utilization repeatedly at the right moment. Disposed on both sides of the bearing the slotted ring 32 and the absorbent material 33, such design allows to suspend and store more lubricating oil capacity, which is beneficial to the life cycle of the entire fan.

By means of the above-mentioned design, the present invention not only blocks and suspends the rising lubricating oil, but also provides the flow-guiding function for lubricating oil so that the absorbent material absorbs and stores the lubricating oil for repeated absorption and utilization by the bearing, effectively preventing the lubricating oil from draining, getting rid off the attrition between the spindle and the bearing and prolonging the life cycle of the motor. Therefore, the present invention not only has a novelty and a progressiveness, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A bearing structure having a bore axially penetrating said bearing structure, an slotted ring located on a periphery over an end penetrated by said bore and disposed with an absorbent material for absorbing and storing lubricating oil.

2. The bearing structure of claim 1, wherein said end with said slotted ring on said periphery is disposed a plurality of radial guiding slots.

3. The bearing structure of claim 1, wherein a periphery of said bearing is disposed a plurality of vertical guiding slots.

4. The bearing structure of claim 1, wherein said absorbent material is an oil absorbent.

5. The bearing structure of claim 1, wherein said absorbent material is a woolen felt.
